(19) United States
(12) Patent Application Publication
(10) Pub. No.: US 2010/0181878 A1
(43) Pub. Date: Jul. 22, 2010

(54) POWER OUTPUT DEVICE AND POWER ENHANCEMENT MEMBER

(76) Inventor: CHUN KWAN YU, HONG KONG (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/357,407

(22) Filed: Jan. 22, 2009

(51) Int. Cl. H02K 7/14; F03G 7/10

(52) U.S. Cl. 310/75 A; 74/DIG. 9

(57) ABSTRACT

A power output device and a power enhancement member are provided. The power output device includes: a basic power supply member, a driving shaft, an output shaft, a clutch and a power enhancement member. The power enhancement member includes a rotation portion and a plurality of weight elements arranged on the rotation portion. In operation, the rotation portion rotates together with and around the output shaft, the plurality of weight elements in turn rotate together with the rotation portion around the output shaft. Meantime, the plurality of weight elements also make predetermined reciprocating movement relative to the rotation portion, such that the center of gravity of the power enhancement member is always offset from the output shaft towards a constant direction, thereby to promote and stabilize the rotation of the output shaft. The present invention is especially useful in applications that need large power output.

### BACKGROUND OF THE INVENTION

1. Field of the Invention

The present invention relates to a power output device, and more particularly, to a power output device with enhanced stability. The present invention further relates to a power enhancement member.

2. Discussion of the Related Art

Electric vehicles, compared with internal combustion engine vehicles, are mechanically simple, release almost no air pollutants and have fewer operation and transmission parts. Nowadays, Electric vehicles are hitting the mainstream. However, because of the use of the battery, electric vehicles have worse starting performance compared with gasoline-fueled vehicles.

In some lager-scale engineering machines, such as crane, crusher or road roller and the like, due to the heavy load applied on the engine and the fluctuation of the load, the engine tends to wobble. In extreme cases it may even cause severe damage to the engine and the transmission system.

Therefore, there is a need for a power output device which can promote and stabilize the power output.

### SUMMARY OF THE INVENTION

Accordingly, the present invention provides a power output device, which can promote and stabilize the power output, and decrease the disturbance from the external load.

In an embodiment, a power output device is provided, which includes a basic power supply member, a driving shaft, an output shaft, a clutch and a power enhancement member. The clutch is connected with the driving shaft and the output shaft. The power enhancement member is disposed on the output shaft, and includes a rotation portion and a plurality of weight elements arranged on the rotation portion. The rotation portion rotates together with the output shaft, and the weight elements in turn rotate together with the rotation portion. Meanwhile, the plurality of weight elements also make predetermined reciprocating movement relative to the rotation portion, so that the center of gravity of the power enhancement member is always offset from the output shaft towards a constant direction, thereby to promote and stabilize the rotation of the output shaft.

In one aspect of the invention, the basic power supply member is an engine, and the power receiving object is a driving wheel used to drive a crane. However, the basic power supply member may also be a motor, and the power receiving object may also be a driving wheel used to drive a motor vehicle.

The present invention also provides a power enhancement member, which includes a rotation portion and a plurality of weight elements arranged on the rotation portion. The rotation portion rotates together with and around the output shaft used to output power. When the rotation portion rotates, the plurality of weight elements in turn rotate together with the rotation portion. Meanwhile, the plurality of weight elements also make predetermined reciprocating movement relative to the rotation portion, such that the center of gravity of the power enhancement member is always offset from the output shaft towards a constant direction, thereby to promote and stabilize the rotation of the output shaft.

The power output device according to the present invention can increase the inertia of the output shaft through the application of the power enhancement member, thus the power output is more stable and smoother. When used in electric vehicles, the vehicles can start up more quickly due to the accumulation of the inertia. In the case when a large-power output is needed, for example when used in a crane, the advantage of the present invention to output stable and smooth power is more prominent.

### BRIEF DESCRIPTION OF THE DRAWINGS

The present invention will now be described more fully hereinafter through various embodiments with reference to the accompanying drawings, wherein the drawings are not drawn to scale, in which:

FIG. 1 is a schematic view of a power output device according to an embodiment of the present invention;

FIG. 2 is a schematic cross section view of a power enhancement member according to an embodiment of the present invention;

FIG. 3 is a schematic side view of the power enhancement member of FIG. 2;

FIG. 4 is a schematic plan view of a power enhancement member according to another embodiment of the present invention;

FIG. 5 is a schematic cross section view of the power enhancement member according to still another embodiment of the present invention;

FIG. 6 is a schematic plan view of a power enhancement member according to a yet another embodiment of the present invention;

FIG. 7 is a schematic plan view of a power enhancement member according to a further embodiment of the present invention;

FIG. 8 is a schematic plan view of a fixed plate of the power enhancement member in FIG. 7; and

FIG. 9 is a schematic plan view of a rotation portion and a plurality of weight elements of the power enhancement member in FIG. 7.

### DESCRIPTION OF THE PREFERRED EMBODIMENTS

Like reference numbers and designations in the various drawings indicate like elements. For the sake of concision, one element might appear in different views but might only be denoted in some of the views.

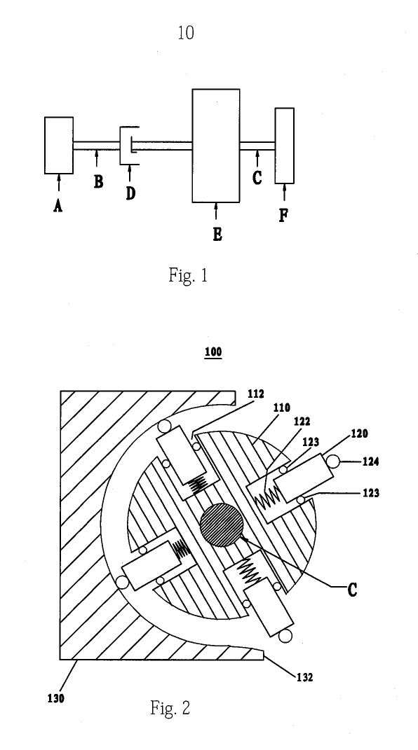

Referring to FIG. 1, a power output device 10 according to an embodiment of the present invention is shown in a schematic view. This power output device 10 includes a basic power supply member A, a driving shaft B, an output shaft C, a clutch D, and a power enhancement member E. The driving shaft B is connected with the basic power supply member A. The output shaft C is connected with a power receiving object F to output power. The clutch D is connected with both the driving shaft B and the output shaft C to control the coupling and decoupling between the driving shaft B and the output shaft C. The power enhancement member E is disposed on the output shaft C. In this example, the basic power supply member A is an engine and the power receiving object F is a driving wheel used to drive a crane. Please note that the basic power supply member A may also be a motor and the power receiving object F may also be a driving wheel used to drive a motor vehicle.

In most of the power output devices of prior art, the driving shaft of the basic power supply member is directly connected to the power receiving object. Such configuration tends to cause problems such as instability of the power device and a slower start-up, as mentioned above.

In the present invention, a power enhancement member E is introduced between the basic power supply member A and the power receiving object F. The power enhancement member E is provided with features to stabilize and promote the power output, which will be described more fully hereinafter, such that the power output of the power output device 10 is less disturbed by external load, thereby to ensure a stable and enhanced power output.

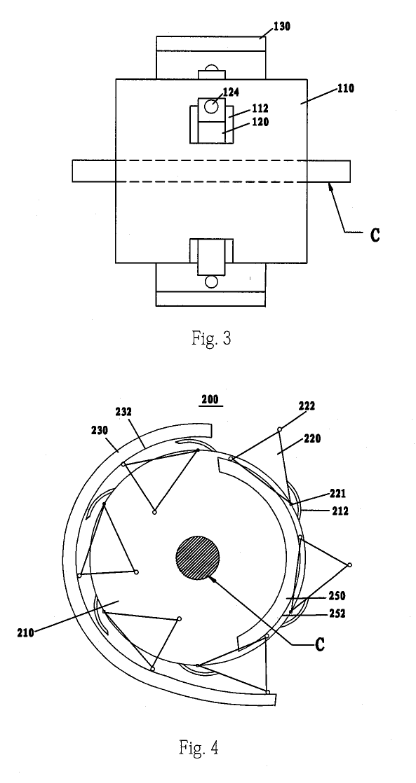

Referring to FIG. 2 and FIG. 3, a power enhancement member according to the embodiment of FIG. 1 is shown in a schematic cross section view and a schematic side view respectively.

The power enhancement member 100 in this embodiment includes a rotation portion 110, a plurality of weight elements 120 and a guiding block 130 located at one side thereof. The guiding block 130 has an arc shaped guiding surface 132. The rotation portion 110 is connected with the output shaft C and rotates together with the output shaft C. The rotation portion 110 is of substantially cylindrical shape and is provided with a plurality of chambers 112 evenly around its circumference to receive the plurality of weight elements 120 respectively. The proximal end (i.e., the end near to the output shaft C) of each of the weight elements 120 is connected to the bottom (not shown) of the chamber 112 via a spring 122, and the sides of each of the weight elements 120 are in movable contact with the chamber 112 through rollers 123. The distal end of each of the weight elements 120 is provided with a roller 124, which is used to define the motion track of the weight elements 120 by contacting with the guiding surface 132, as will be discussed below.

The operation of the enhancement member 100 of this embodiment will be described in the following. When the rotation portion 110 rotates together with the output shaft C, each of the weight elements 120 in turn rotates together with the rotation portion 110. When the weight element 120 rotates to the bottom of the rotation portion 110 shown in FIG. 2 and gets close to the guiding block 130, the roller 124 at the distal end of the weight element 120 contacts with the guiding surface 132. Then the weight element 120 moves inward of the chamber 112 against the resistance of the spring 122 under the pressure of the guiding surface 132. That is to say, the weight element 120 rotating to the left of FIG. 2 is rolling along the guiding surface 132 under the pressure of the roller 124 at its distal end while rotating around the output shaft C.

When the weight element 120 rotates to the top of the rotation portion 110 shown in FIG. 2, it starts to rotate away from the guiding surface 132. Thereafter, the weight element 120 moves outward of the chamber 112 under the pressure of the spring 122.

From the foregoing description, it is to be understood that the relative movement between the weight elements 120 and the rotation portion 110 is linear reciprocating movement along the radial direction of the rotation portion 110, such that the center of gravity of the power enhancement member 110 is always offset from the output shaft C towards a constant direction to the right. With this eccentric and imbalanced configuration, the inertia of the power enhancement member 100 may be adjusted and the rotation unbalance be enhanced by appropriately selecting the weight and number of the weight elements 120 and the elastic coefficient of the spring 122. The inventor has done many experiments, which prove that a power output device with a power enhancement member 100 of the present invention can produce a power output with better stability. Furthermore, even in the case when the original power output of the basic power supply member such as a motor is very low, a higher power output can be produced through the operation of the power enhancement member 100.

As shown in FIG. 3, one group of weight elements 120 are disposed along the axial direction of the rotation portion 110, including four weight elements 120 arranged evenly around the circumference of the rotation portion 110. However, note that the number and the arrangement of the weight elements 120 are not limited to this. There may be any number of groups of weight elements 120, and more weight elements 120 may also be arranged along the circumference. Note also that in this embodiment, the sides of the weight elements 120 are in movable contact with the chambers 112 through rollers 123, however, the present invention is not limited to this, other structures such as slide rails may also be used to replace the rollers 123.

Referring to FIG. 4, a power enhancement member 200 according to another embodiment of the present invention is shown in a schematic plan view. The power enhancement member 200 is similar to the power enhancement member 100 in FIG. 2, which includes a rotation portion 210, a plurality of weight elements 220 and a first guiding block 230 located outside of one side thereof. Moreover, the power enhancement member 200 further includes a second guiding block 250 at the other side. The first guiding block 230 has an arc shaped first surface 232, and the second guiding block 250 has an arc shaped second surface 252. The weight elements 220, being of generally triangular shape, are pivotally connected to the rotation portion 210 through an endpoint 221. When the weight element 220 rotates near to the first guiding block 230 and contacts the first guiding surface 232, the weight element 220 pivots towards the output shaft C under the pressure of the first guiding surface 232. When the weight element 220 rotates near to the second guiding block 250 and contacts the second guiding surface 252, the weight element 220 pivots away from the output shaft C under the pressure of the second guiding surface 252. Such configuration ensures that the center of gravity of the power enhancement member 200 remains offset from the output shaft C towards a constant direction to the right.

Wherein, each of the weight elements 220 is provided with a roller 222 at a contact portion with the first guiding surface 232 or with the second guiding surface 252. When the weight element 220 rotates near to the first guiding block 230 or the second guiding block 250, the roller 222 contacts the first guiding surface 232 or the second guiding surface 252 accordingly. Therefore, the weight elements 220 can roll on the first guiding surface 232 or the second guiding surface 252 by means of the rollers 222 so as to reduce the friction. In addition, stop rods 212 may be provided at the rotation portion 210 near the endpoints 221 of the weight elements 220, to prevent the turnover of the weight element 220 due to the outward movement when rotating to the right side of the output shaft C. Alternatively, protective baffles (not shown), instead of the stop rods 212, may be provided at the right side of the rotation portion 210 to prevent the turnover of the weight elements 220.

Referring to FIG. 5, a power enhancement member 300 according to yet another embodiment of the present invention is shown in a schematic cross section view. In this embodiment, the power enhancement member 300 is similar to the power enhancement member 100 of FIG. 2, which also includes a rotation portion 310 and a plurality of weight elements 320. Moreover, the power enhancement member 300 further includes an eccentric frame 330, which is fixed in position, such as in fixed connection with the ground. The rotation portion 310 is in a hollow cylinder form and is provided with a plurality of chambers 311 arranged evenly around the circumference to receive the plurality of weight elements 320 respectively. The proximal end of each of the weight elements 320 is connected to the eccentric frame 330 via a connecting rod 321. The connecting rod 321 is slidably connected to the eccentric frame 330 through a guide ring 322 at one end thereof. The sides of each of the weight elements 220 are in movable contact with the respective chamber 311 through rollers 323 (sliding rails may also be used as an alternative). The geometric center of the eccentric frame 330 is offset from the output shaft C so that the weight elements 320 can make linear reciprocating movement along the radial direction of the rotation portion 310 while rotating together with the rotation portion 310. Such movement ensures that the center of gravity of the power enhancement member 300 remains offset from the output shaft C towards a constant direction to the right. Note that in this embodiment, a hook may also be used to replace the guide ring 322.

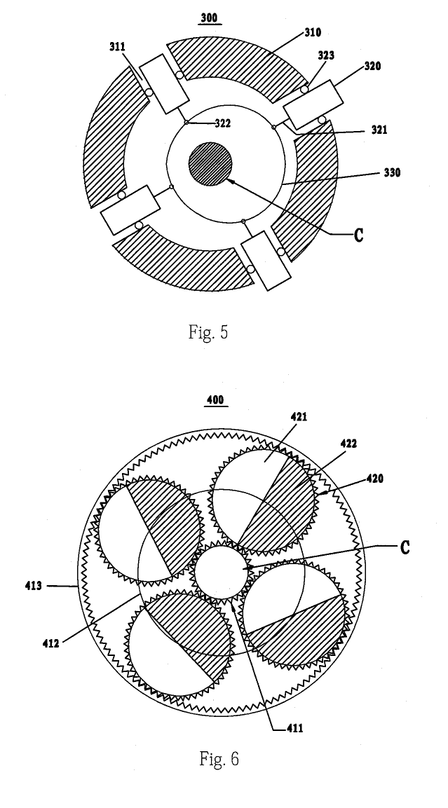

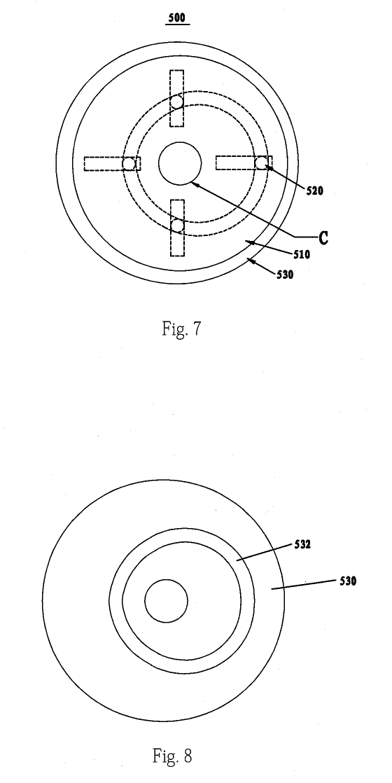

Referring to FIG. 6, a power enhancement member 400 according to still another embodiment of the present invention is shown in schematic plan view. In this embodiment, the power enhancement member 400 also includes a rotation portion and a plurality of weight elements (4 weight elements are shown as an example). The rotation portion mainly consists of a center gear 411, a gear bracket 412 and an external gear 413. The weight elements are in the form of planetary gears 420. Each of the weight elements 420 is configured to have a structure with offset center of gravity, i.e., one side 421 of each of the weight elements 420 is lighter than the other side 422. This offset of the center of gravity can be realized by either constructing the two sides of the weight elements 420 using two different materials with different densities, or forming a hollow space inside one side 421 of the weight element 420. The plurality of weight elements 420 may be connected together by the gear bracket 412, and arranged between the center gear 411 and the external gear 413. The center gear 411 is disposed on the output shaft C and rotates together with the output shaft C. The teeth number of the center gear 411, the weight elements 420 and the external gear 413 may be appropriately set so that the center of gravity of the plurality of weight elements 420 as a whole is always offset from the output shaft C towards a constant direction at any moment during the rotation of the rotation portion.

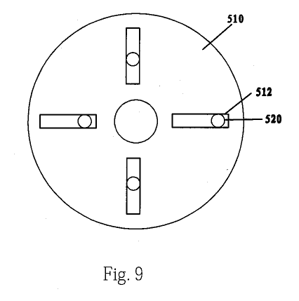

Referring to FIG. 7 to FIG. 9, a power enhancement member 500 according to a further embodiment of the present invention is shown in a schematic plan view and in exploded views. In this embodiment, the power enhancement member 500 is similar to the power enhancement member 100 of FIG. 2 in that it also includes a rotation portion 510 and a plurality of weight elements 520. The difference lies in that the power enhancement member 500 further includes a fixed plate 530, which is fixed in position and has an eccentric track 532 thereon. The plurality of weight elements 520 are in sphere form. The depth of the eccentric track 532 is about one third of the diameter of the weight element 520. The rotation portion 510 is in a disk form, and is provided with a plurality of grooves 512 in one side to receive the plurality of weight elements 520 respectively. The depth of the grooves 512 is about on third of the diameter of the weight element 520. During assembling, the side of the fixed plate 530 having the eccentric track 532 faces towards the side of the rotation portion 510 having grooves 512, so that the weight elements 520 are placed in the space formed by the eccentric track 532 and the grooves 512. The geometric center of the eccentric track 532 is offset from the output shaft C, such that the weight elements 520 make linear reciprocating movement along the radial direction in the grooves 512 of the rotation portion 510 while rotating along the eccentric track 532.

It should be noted that the number of the weight elements in various embodiments is only illustrative, and any number of weight elements may be chosen as needed in practical application. Some other parameters, for example, the mass of the weight elements and the diameter of the output shaft, may also be specifically designed as needed. Similarly, the number of the rollers on the sides of the weight elements shown in FIG. 2 and FIG. 5 is not limited to two, there may be any number of rollers as appropriate, for instance four. Alternatively, in FIG. 2 and FIG. 5, the four sides of the weight elements may all be equipped with the rollers in order to define a more stable motion track for the weight elements. Moreover, the weight elements may also be provided with guide rails at one or more sides, and at the same time the sides of the chambers for the weight elements may be provided with guide slots to mate with the guide rails, so as to guide the linear reciprocating movement of the weight elements in the chamber.

The terms of direction “above”, “under”, “left”, “right” and the like used herein are used just for the convenience of description. If the observation point is changed in different applications, the specific terms should also be changed accordingly.

While various preferred embodiments of the present invention have been described above, those skilled in the art can make various alterations and variations to the present invention without departing from the spirit and the scope of the present invention. All those alternations and variations are considered to be within the scope of the invention as defined in the appended claims.

1. A power output device comprising:
a basic power supply member;
a driving shaft, connected with the basic power supply member;
an output shaft, connected with a power receiving object in order to output power; and
a clutch, used for controlling the coupling and decoupling between the driving shaft and the output shaft, the clutch being connected with the driving shaft and the output shaft,
wherein the power output device further comprises a power enhancement member disposed on the output shaft, the power enhancement member comprises a rotation portion and a plurality of weight elements arranged on the rotation portion, the rotation portion is connected with the output shaft and rotates together with the output shaft, when the rotation portion rotates, the plurality of weight elements rotate together with the rotation portion around the output shaft, meanwhile, the plurality of weight elements also make a predetermined reciprocating movement relative to the rotation portion respectively, such that the center of gravity of the power enhancement member is always offset from the output shaft towards a constant direction, thereby promoting and stabilizing the rotation of the output shaft.

2. The power output device of claim 1, wherein the basic power supply member is an engine, and the power receiving object is a driving wheel used for driving a crane.

3. The power output device of claim 1, wherein the basic power supply member is a motor, and the power receiving object is a driving wheel used for driving a motor vehicle.

4. The power output device of claim 1, wherein the power enhancement member further comprises a guiding block located at one side, the guiding block having an arc shaped guiding surface,
the rotation portion is of cylindrical shape, and is provided with a plurality of chambers evenly around its circumference to receive the plurality of weight elements respectively, wherein, the proximal end of each of the weight elements is connected to the bottom of the respective chamber through a spring, and the sides of each of the weight elements are in movable contact with the respective chamber through rollers or slide rails,
when the weight element rotates near to the guiding block and contacts the guiding surface, the weight element moves inward of the chamber under the pressure of the guiding surface,
when the weight element rotates away from the guiding surface, the weight element moves outward of the chamber under the force of the spring.

5. The power output device of claim 4, wherein each of the weight elements is provided with a roller at the distal end, which contacts the guiding surface when the weight element rotates near to the guiding surface.

6. The power output device of claim 1, wherein,
the rotation portion comprises a center gear, a gear bracket and an external gear,
the plurality of weight elements are in the form of planetary gears, each of which is configured to have a structure with offset center of gravity, and the plurality of weight elements are connected together by the gear bracket and are arranged between the center gear and the external gear,
the center gear is disposed on the output shaft and rotates together with the output shaft, and
the teeth number of the center gear, the plurality of weight elements and the external gear are configured such that the center of gravity of the plurality of weight elements as a whole remain offset from the output shaft toward a constant direction at any moment during the rotation of the rotation portion.

7. The power output device of claim 1, wherein, the power enhancement member further comprises a first guiding block at one side and a second guiding block at the other side, the first guiding block having an arc shaped first guiding surface and the second guiding block having an arc shaped second guiding surface,
the weight elements are of generally triangular shape with three endpoints, each of which is pivotally connected to the rotation portion by one of the endpoints,
when the weight element rotates near to the first guiding block together with the rotation portion and contacts the first guiding surface, the weight element pivots towards the output shaft under the pressure of the first guiding surface, and
when the weight element rotates near to the second guiding block together with the rotation portion and contacts the second guiding surface, the weight element pivots away from the output shaft under the pressure of the second guiding surface.

8. The power output device of claim 7, wherein each of the weight elements is provided with a roller at the distal end thereof, and when the weight element rotates near to the first guiding block or the second guiding block, the roller contacts with the respective first guiding surface or second guiding surface.

9. The power output device of claim 1, wherein, the power enhancement member further comprises an eccentric frame, which is fixed in position,
the rotation portion is in a hollow cylindrical form, and is provided with a plurality of chambers evenly around the circumference to receive the plurality of weight elements respectively, the proximal end of each of the weight elements is connected to the eccentric frame via a connecting rod, which is slidably connected to the eccentric frame via a guide ring at one end, and the sides of each of the weight elements are in movable contact with the respective chamber through rollers or slide rails, and
the geometric center of the eccentric frame is offset from the output shaft, such that the weight elements make linear reciprocating movement along the radial direction of the rotation portion while rotating together with the rotation portion.

10. The power output device of claim 1, wherein the power enhancement member further comprises a fixed plate, which is fixed in position, and the fixed plate is provided with an eccentric track thereon,
the plurality of weight elements are in sphere form, and the depth of the eccentric track is about one third of the diameter of the weight elements,
the rotation portion is in a disk form, and is provided with a plurality of grooves evenly arranged in one side to receive the plurality of weight elements respectively, the depth of the grooves is about one third of the diameter of the weight elements,
wherein the surface of the fixed plate having the eccentric track faces toward the surface of the rotation portion having the grooves, so that the weight elements are placed in a space formed by the eccentric track and the grooves,
the geometric center of the eccentric tack is offset from the output shaft, such that the weight elements make linear reciprocating movement along the radial direction in the grooves of the rotation portion while rotating together with the rotation portion along the eccentric track.

11. A power enhancement member, comprising:
a rotation portion; and
a plurality of weight elements arranged on the rotation portion, wherein, the rotation portion rotates, together with and around the output shaft used to output power, when the rotation portion rotates, the plurality of weight elements rotate together with the rotation portion, meanwhile, the plurality of weight elements also make predetermined reciprocating movement relative to the rotation portion respectively, such that the center of gravity of the power enhancement member is always offset from the output shaft towards a constant direction, thereby to promote and stabilize the rotation of the output shaft.
